(19) United States
(12) Patent Application Publication
(10) Pub. No.: US 2026/0152624 A1
(43) Pub. Date: Jun. 4, 2026

(54) METHOD FOR PREPARING HIGH-FLUIDITY MAGNETIC COMPOSITE MATERIAL AND PREPARATION METHOD THEREOF

(71) Applicant: Jiangxi Dayou Technology Co., Ltd., Yichun City (CN)

(72) Inventors: Wei ZHOU, Yichun City (CN); Yuchen MAO, Yichun City (CN); Wenlong MAO, Yichun City (CN)

(21) Appl. No.: 19/291,820

(22) Filed: Aug. 6, 2025

(30) Foreign Application Priority Data
Nov. 29, 2024 (CN) 202411731698.4

(51) Int. Cl. C08K 9/04; C08J 3/205; H01F 1/42

(52) U.S. Cl. CPC C08K 9/04; C08J 3/2053; C08J 2363/00; C08K 2201/005; C08K 2201/01; H01F 1/42

(57) ABSTRACT

A high-fluidity magnetic composite material and a preparation method thereof are disclosed. The preparation method includes: providing metal soft magnetic powders with high sphericity having a first particle size, a second particle size, and a third particle size, respectively; grading the metal soft magnetic powders respectively having the above three particle size, and then weighing a graded metal soft magnetic powder and mixing to obtain a first mixture; weighing an organic acid at a first weight percentage, and a diluent at a second weight percentage relative to the first mixture, respectively, and adding the organic acid after diluting to the first mixture to obtain a second mixture; weighing an epoxy resin at a third weight percentage relative to the first mixture, and adding the epoxy resin to the second mixture and mixing; and mixing the epoxy resin with the second mixture to obtain the high-fluidity magnetic composite material.

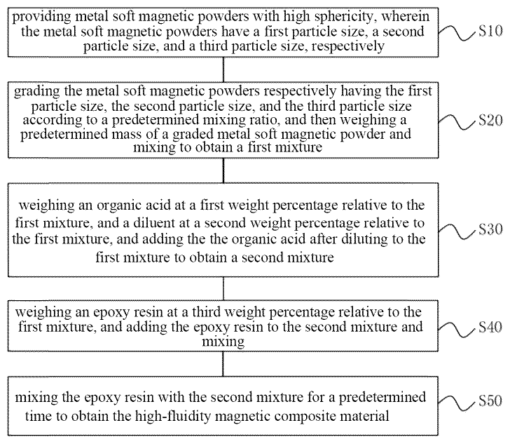

### CROSS REFERENCE TO RELATED APPLICATION

This patent application claims the benefit and priority of Chinese Patent Application No. 202411731698.4, filed on Nov. 29, 2024, the disclosure of which is incorporated by reference herein in its entirety as part of the present application.

### TECHNICAL FIELD

The present disclosure relates to the technical field of magnetic materials, in particular to a high-fluidity magnetic composite material and a preparation method thereof.

### BACKGROUND

Magnetic composite materials, as new type of functional materials that combine magnetic particles with base materials such as polymers, metals, etc., have shown broad application prospects in multiple fields such as electronics, healthcare, aerospace, and automotive. These materials exhibit excellent electronic performance, magnetic properties, and structural characteristics, providing important supports for technological innovation and development in various industries.

Magnetic composite materials, as new type of functional materials, have shown broad application prospects and enormous market potential in multiple fields. With the continuous advancement of technologies and the persistent expansion of application fields, magnetic composite materials will play a significant role in more fields, thereby promoting innovation and development across various industries. Under such application prospects, the present disclosure proposes a method for preparing a high-fluidity magnetic composite material to meet the current market demand for magnetic composite materials with different characteristics.

### SUMMARY

In view of the defects in the prior art, an object of the present disclosure is to provide a high-fluidity magnetic composite material and a preparation method thereof, aiming to meet the market demand for different specific magnetic composite materials by producing high-fluidity magnetic composite materials.

A first aspect of the present disclosure provides method for preparing a high-fluidity magnetic composite material, including the following steps:
providing metal soft magnetic powders with high sphericity, wherein the metal soft magnetic powders have a first particle size, a second particle size, and a third particle size, respectively; the first particle size is 85 μm to 90 μm, the second particle size is 30 μm to 35 μm, and the third particle size is 8 μm to 12 μm;
subjecting the metal soft magnetic powders respectively having the first particle size, the second particle size, and the third particle size to grading according to a predetermined mixing ratio, and then weighing and adding a predetermined mass of a graded metal soft magnetic powder to a mixing device and mixing to obtain a first mixture, the predetermined mixing ratio of the metal soft magnetic powders of the first particle size, the second particle size, and the third particle size being 1:3:9;
weighing an organic acid at a first weight percentage relative to the first mixture, and a diluent at a second weight percentage relative to the first mixture, and mixing the organic acid and the diluent to obtain a diluted organic acid, adding the diluted organic acid to the first mixture in the mixing device and mixing to obtain a second mixture;
weighing an epoxy resin at a third weight percentage relative to the first mixture, and adding the epoxy resin to the second mixture in the mixing device for mixing; the epoxy resin having a molecular weight of 20000 g/mol to 80000 g/mol; and
mixing the epoxy resin with the second mixture for a predetermined time to obtain the high-fluidity magnetic composite material.

According to an aspect of the above technical solutions, in step of weighing and adding the predetermined mass of the graded metal soft magnetic powder to the mixing device and mixing to obtain the first mixture, the mixing is performed at a rotational speed of 50 r/min for 10 minutes. According to an aspect of the above technical solutions, where 10 kg of the graded metal soft magnetic powder is weighed and added to the mixing device; and
where the first weight percentage of the organic acid relative to the first mixture is 1%, and the second weight percentage of the diluent relative to the first mixture is 3%.

According to an aspect of the above technical solutions, where the organic acid is acetic acid and the diluent is ethanol.

According to an aspect of the above technical solutions, where in step of adding the diluted organic acid to the first mixture in the mixing device and mixing to obtain the second mixture, the mixed is performed under conditions comprising:
non-vacuum but closed environment, an environment temperature of 40° C., and a rotational speed of 50 r/min.

According to an aspect of the above technical solutions, the method further comprising: after the step of adding the diluted organic acid to the first mixture in the mixing device and mixing, sieving a resulting mixture after mixing the diluted organic acid with the first mixture using a 60-mesh sieve to obtain a passivated second mixture that passes through the 60-mesh sieve.

According to an aspect of the above technical solutions, where a third weight percentage of the epoxy resin relative to the first mixture is 6%;
in step of adding the epoxy resin to the second mixture in the mixing device and mixing, the mixing is performed under conditions comprising:
non-vacuum but closed environment, an environment temperature of 70° C., and a rotational speed of 40 r/min.

According to an aspect of the above technical solutions, where the mixing the epoxy resin with the second mixture is performed for 15 min.

A second aspect of the present disclosure provides a high-fluidity magnetic composite material prepared by the method according to the above technical solutions.

Compared with the prior art, embodiments of the high-fluidity magnetic composite material according to the present disclosure have the following beneficial technical effects:
1. Powder with high sphericity is used for mixing. During the mixing process, spherical particles exhibit enhanced mutual rolling and sliding capabilities, resulting in that the magnetic composite material after mixing exhibit superior uniformity and consistency, which reduces interparticle friction, and thereby improves flowability.
2. Surface treatment of powder is performed through organic acid passivation, forming a surface layer with organic functional groups, which enhances compatibility with the resin matrix and improves flowability.
3. A particle size gradation ratio conforming to the golden ratio principle is adopted to achieve optimized magnetic performance, where large-sized, medium-sized, and small-sized particles are present in a ratio of approximately 1:3:9.
4. By using an epoxy resin with a specific medium-molecular-weight range (20,000 g/mol to 80,000 g/mol), the composite material achieves high flowability and an appropriate curing time window, which prevents premature curing-induced loss of flowability due to an excessively narrow curing window and imparts adequate strength and toughness to a resulting cured material.
5. The diluent is used to dilute resin and reduce the viscosity of the matrix resin and thereby enhance mixing effect, enabling uniform dispersion of materials and preventing performance degradation of the composite material caused by nonuniform distribution.

### BRIEF DESCRIPTION OF THE DRAWINGS

The above and/or additional aspects and advantages of the present disclosure will become apparent and easily understood from the description of the embodiments in conjunction with the accompanying drawings, where:

The sole FIGURE shows a flowchart describing a method for preparing a high-fluidity magnetic composite material in an embodiment of the present disclosure.

### DETAILED DESCRIPTION

The following detailed description of the embodiments of the present disclosure will be made in conjunction with the accompanying drawings, so that the objects, features and advantages of the present disclosure may be more apparent and comprehensible. Several embodiments of the present disclosure are shown in the accompanying drawings. However, the present disclosure could be implemented in many different forms and is not limited to the embodiments described herein. On the contrary, the purpose of providing these embodiments is to make the disclosure of the present disclosure more thorough and comprehensive.

Unless otherwise defined, all technical and scientific terms used herein shall have the same meanings as commonly understood by one of skilled in the art to which the present disclosure pertains. The terms used in the specification of the present disclosure are only for the purpose of describing specific embodiments and are not intended to limit the present disclosure. The term “and/or” used herein includes any and all combinations of one or more related listed items.

A first aspect of the present disclosure provides method for preparing a high-fluidity magnetic composite material, including the following steps:
providing metal soft magnetic powders with high sphericity, where the metal soft magnetic powders have a first particle size, a second particle size, and a third particle size, respectively; the first particle size is 85 μm to 90 μm, the second particle size is 30 μm to 35 μm, and the third particle size is 8 μm to 12 μm;
subjecting the metal soft magnetic powders respectively having the first particle size, the second particle size, and the third particle size to grading according to a predetermined mixing ratio, and then weighing and adding a predetermined mass of a graded metal soft magnetic powder to a mixing device and mixing to obtain a first mixture, the predetermined mixing ratio of the metal soft magnetic powders of the first particle size, the second particle size, and the third particle size being 1:3:9;
weighing an organic acid at a first weight percentage relative to the first mixture, and a diluent at a second weight percentage relative to the first mixture, and mixing the organic acid and the diluent to obtain a diluted organic acid, adding the diluted organic acid to the first mixture in the mixing device and mixing to obtain a second mixture;
weighing an epoxy resin at a third weight percentage relative to the first mixture, and adding the epoxy resin to the second mixture in the mixing device for mixing; the epoxy resin having a weight average molecular weight of 20000 g/mol to 80000 g/mol; and
mixing the epoxy resin with the second mixture for a predetermined time to obtain the high-fluidity magnetic composite material.

In some embodiments, in step of weighing and adding the predetermined mass of the graded metal soft magnetic powder to the mixing device and mixing to obtain the first mixture, the mixing is performed at a rotational speed of 50 r/min for 10 minutes.

In some embodiments, 10 kg of the graded metal soft magnetic powder is weighed and added to the mixing device; and
where the first weight percentage of the organic acid relative to the first mixture is 1%, and the second weight percentage of the diluent relative to the first mixture is 3%.

In some embodiments, the organic acid is acetic acid and the diluent is ethanol.

In some embodiments, where in step of adding the diluted organic acid to the first mixture in the mixing device and mixing to obtain the second mixture, the mixed is performed under conditions comprising:
non-vacuum but closed environment, an environment temperature of 40° C., and a rotational speed of 50 r/min.

In some embodiments, the method further includes: after the step of adding the diluted organic acid to the first mixture in the mixing device and mixing, sieving a resulting mixture after mixing the diluted organic acid with the first mixture using a 60-mesh sieve to obtain a passivated second mixture that passes through the 60-mesh sieve.

In some embodiments, a third weight percentage of the epoxy resin relative to the first mixture is 6%;
in step of adding the epoxy resin to the second mixture in the mixing device and mixing, the mixing is performed under conditions comprising:
non-vacuum but closed environment, an environment temperature of 70° C., and a rotational speed of 40 r/min.

In some embodiments, the mixing the epoxy resin with the second mixture is performed for 15 min.

A second aspect of the present disclosure provides high-fluidity magnetic composite material prepared by the method according to the above technical solutions.

Compared with the prior art, embodiments of the high-fluidity magnetic composite material according to the present disclosure have the following beneficial technical effects:
1. Powder with high sphericity is used for mixing. During the mixing process, spherical particles exhibit enhanced mutual rolling and sliding capabilities, resulting in that the magnetic composite materials after mixing exhibit superior uniformity and consistency, which reduces interparticle friction, and thereby improves flowability.
2. Surface treatment of powder is performed through organic acid passivation, forming a surface layer with organic functional groups, which enhances compatibility with the resin matrix and improves flowability.
3. A particle size gradation ratio conforming to the golden ratio principle is adopted to achieve optimized magnetic performance, where large-sized, medium-sized, and small-sized particles are present in a ratio of approximately 1:3:9.
4. By using an epoxy resin with a specific medium-molecular-weight range (20,000 g/mol to 80,000 g/mol), the composite material achieves high flowability and an appropriate curing time window, which prevents premature curing-induced loss of flowability due to an excessively narrow curing window and imparts adequate strength and toughness to a resulting cured material.
5. The diluent is used to dilute resin and reduce the viscosity of the matrix resin and thereby enhance mixing effect, enabling uniform dispersion of materials and preventing performance degradation of the composite material caused by nonuniform distribution.

### Example 1

The FIGURE and Example 1 describe a method for preparing a high-fluidity magnetic composite material, the method was conducted by S10 to S50:
S10: metal soft magnetic powders with high sphericity were provided, where the metal soft magnetic powders had a first particle size, a second particle size, and a third particle size, respectively.

Metal soft magnetic powders were soft magnetic materials used in the art, including but not limited to at least one of carbonyl iron powder, Fe—Ni—Mo alloy powder, Fe—Ni alloy powder, Fe—Co alloy powder, Fe—Si alloy powder, Fe—Si—Al alloy powder, Fe—Si—Cr alloy powder, Fe-based amorphous alloy powder, Ni-based amorphous alloy powder, Co-based amorphous alloy powder, and Fe-based nanocrystalline powder, and the soft magnetic metal powders must be powders with high sphericity.

By way of example and not as a limitation, a metal soft magnetic powder in Example 1 was Fe—Si alloy soft magnetic powder. However, the metal soft magnetic powder was not limited to Fe—Si alloy soft magnetic powder, and other unlisted metal soft magnetic powders were also applicable.

Specifically, the metal soft magnetic powder having the first particle size was large particle size powder, with a D50 (i.e. median particle size) of 85 μm to 90 μm, the metal soft magnetic powder having the second particle size was medium particle size powder, with a D50 of 30 μm to 35 μm, and the metal soft magnetic powder having the third particle size was small particle size powder, with a D50 of 8 μm to 12 μm.
S20, the metal soft magnetic powders respectively having the first particle size, the second particle size, and the third particle size, were graded according to a predetermined mixing ratio, and a predetermined mass of a graded metal soft magnetic powder was weighed, and then added into a mixing device and mixed to obtain a first mixture.

In this Example 1, the metal soft magnetic powder having the first particle size, the metal soft magnetic powder having the second particle size, and the metal soft magnetic powder having the third particle size were graded at a mixing ratio of 1:3:9, and 10 kg of a resulting graded metal soft magnetic powder with high sphericity was weighed and then added into a mixing device and mixed at a rotational speed of 50 r/min for 10 min.
S30, a first weight percentage of an organic acid relative to the first mixture, a second weight percentage of a diluent relative to the first mixture were weighed respectively, and then mixed to obtain a diluted organic acid. The diluted organic acid was added to the first mixture in the mixing device and mixed to obtain a second mixture.

In this Example 1, the organic acid was acetic acid, and the first weight percentage of the acetic acid relative to the first mixture was 1%; the diluent was ethanol, and the second weight percentage of the ethanol relative to the first mixture was 3%.

Specifically, 1% by weight of acetic acid and 3% by weight of ethanol relative to the first mixture (i.e. the graded metal soft magnetic powder) were weighed and mixed evenly, followed by pouring into a mixed device. A resulting mixture was further mixed thoroughly under conditions: non-vacuum but closed space, a temperature of 40° C., and a rotational speed of 50 r/min. After the diluent therein was fully volatilized as determined by a weight loss method, a resulting mixture was sieved using 60-mesh sieve to obtain a passivated second mixture that passed through the 60-mesh sieve, i.e. the metal soft magnetic powder passivated by organic acid.
S40, a third weight percentage of an epoxy resin relative to the first mixture was weighed and then added to the second mixture in the mixing device, and mixed.

In this example, the epoxy resin was a medium-molecular-weight epoxy resin (20000 g/mol to 80000 g/mol).

Specifically, 6% by weight of the medium-molecular-weight epoxy resin relative to the first mixture (i.e., the graded metal soft magnetic powder) was weighed and added into the mixing device and mixed with the second mixture under conditions: non-vacuum but closed space, a temperature of 70° C., and a rotational speed of 40 r/min.

In addition, 6% by weight of ethanol relative to the first mixture (i.e., the graded metal soft magnetic powder) was also mixed with the second mixture by adding into the mixing device together with the epoxy resin. Specifically, the epoxy resin was first mixed with ethanol, and a resulting mixture was then adding into the mixing device and mixed with the second mixture.
S50, the epoxy resin was mixed with the second mixture for a predetermined time to obtain the high-fluidity magnetic composite material.

In this case, the epoxy resin and ethanol were mixed with the second mixture for 15 min. A resulting mixture was taken out after the mixing to obtain the high-fluidity magnetic composite material, which is used for making magnetic powder, etc.

The fluidity of the magnetic composite material prepared by the method in this example was tested. Results are shown in Table 1.

The inductance, permeability and loss performance at different frequencies and magnetic field strengths of the magnetic composite material prepared by the method in this example were tested. The results are shown in Table 2.

The fluidity of the magnetic composite material prepared by the method in this example was tested. The results are shown in Table 3.

The fluidity of the magnetic composite material prepared by the method in this example was tested. The results are shown in Table 4.

### Example 2

Example 2 (i.e. Comparative Example 1) also provided a method for preparing a high-fluidity magnetic composite material. The method was the same as that in Example 1, except that the sphericity of the soft magnetic metal powder, i.e. Fe—Si alloy soft magnetic powder was different. In this example, Fe—Si alloy soft magnetic powder with low sphericity was used, and other steps, parameter and the amounts of the ingredients were the same as those in Example 1.

In this case, the fluidity of the magnetic composite material prepared by the method in Example 1 was tested. Results are shown in Table 1.

### Example 3

Example 3 (i.e. Comparative Example 2) also provided a method for preparing a high-fluidity magnetic composite material. The method was the same as that in Example 1, except that the sphericity of the soft magnetic metal powder, i.e. Fe—Si alloy soft magnetic powder was different. In this example, crushed Fe—Si alloy soft magnetic powder was used, and other steps, parameter and the amounts of the ingredients were the same as those in Example 1.

In this case, the fluidity of the magnetic composite materials prepared by the method in Example 1 to Example 3 were tested. Results are shown in Table 1.

TABLE 1

| | | | Temper- | Pressure | |
|---|---|---|---|---|---|
| Sample | Weight | Pressure | ature | Holding Time | Flow Length |
| Example 1 | 80 g | 15 Mpa | 175° C. | 35 s | 170 mm |
| Example 2 | 80 g | 15 Mpa | 175° C. | 35 s | 80 mm |
| Example 3 | 80 g | 15 Mpa | 175° C. | 35 s | 40 mm |

It can be seen from Table 1 that, given the same pressure, temperature, pressure holding time and weight, a higher sphericity of the metal soft magnetic powder results in better fluidity of the magnetic composite prepared by the same preparation method. For example, the flow length of the magnetic composite material prepared by the method in Example 1 is 170 mm, showing better fluidity than those in Example 2 and Example 3.

### Example 4

Example 4 (i.e. Comparative Example 3) also provided a method for preparing a high-fluidity magnetic composite material. The method was the same as that in Example 1, except that the particle size grading of the soft magnetic metal powder, i.e. Fe—Si alloy soft magnetic powder was different. In this example, the metal soft magnetic powder was all Fe—Si alloy powder having the first particle size (i.e. large particle size), with a D50 of 85 μm to 90 μm, and other steps, parameter and the amounts of the ingredients were the same as those in Example 1.

The inductance, permeability and loss performance at different frequencies and magnetic field strengths of the magnetic composite material prepared by the method in Example 2 were tested. Results are shown in Table 2.

### Example 5

Example 4 (i.e. Comparative example 4) also provided a method for preparing a high-fluidity magnetic composite material. The method was the same as that in Example 1, except that the particle size grading of the soft magnetic metal powder, i.e. Fe—Si alloy soft magnetic powder was different. In this example, the metal soft magnetic powder is all Fe—Si alloy powder with the third particle size (i.e. small particle size), and its D50 of 8 μm to 12 μm, and other steps, parameter and the amounts of the ingredients were the same as those in Example 1.

The inductance, permeability and loss performance at different frequencies and magnetic field strengths of the magnetic composite material prepared by the method in this example were tested. Results are shown in Table 2.

### Example 6

Example 6 (i.e. Comparative example 5) also provided a method for preparing a high-fluidity magnetic composite material. The method was the same as that in Example 1, except that the particle size grading of the soft magnetic metal powder, i.e. Fe—Si alloy soft magnetic powder was different. In this example, Fe—Si alloy powders of the first particle size and the third particle size were adopted as the metal soft magnetic powder, with a ratio of the first particle size to the third particle size of 1:2, and a D50 of 8 μm to 12 μm, and other steps, parameter and the amounts of the ingredients were the same as those in Example 1.

The inductance, permeability and loss performance at different frequencies and magnetic field strengths of the magnetic composite material prepared by the method in example 4 to example 6 were tested. Results are shown in Table 2.

TABLE 2

| | Inductance | Magnetic | Loss (kW/m³) | | | |
|---|---|---|---|---|---|---|
| Sample | (μH) | Permeability | 50 kHZ/50 mT | 50 kHZ/100 mT | 100 kHZ/50 mT | 100 kHZ/100 mT |
| Example 1 | 113.02 | 145.6 | 40.358 | 145.13 | 110.01 | 408.86 |
| Example 4 | 126.52 | 162.8 | 135.29 | 529.33 | 373.42 | 1242.78 |
| Example 5 | 70.66 | 90.8 | 28.75 | 130.03 | 80.85 | 350.16 |
| Example 6 | 99.54 | 128 | 65.94 | 273.94 | 167.38 | 677.14 |

It can be seen form Table 2 that the particle size of the powder directly affects the magnetic properties of the composite material. In Example 4, large-sized powders were used, and the results reveal that the magnetic composite material prepared with large-sized powder exhibits high magnetic permeability, but concurrently suffers from high loss. In Example 5, small-sized powders were used, and the results reveal that the magnetic composite material prepared with large-sized powder exhibits low loss, but concurrently low magnetic permeability. In Example 6, regular particle size of the power were graded, and the results reveal that the magnetic composite material prepared with resulting graded powder exhibits relatively high magnetic permeability and low loss.

Combining Table 1 and Table 2, in Example 1, the metal soft magnetic powder graded at a golden ratio of 1:3:9 was used. The results show that the golden ratio of the graded metal soft magnetic powder according to the present disclosure exhibits higher permeability and lower loss than the conventional grading ratio of the graded metal soft magnetic powder.

### Example 7

Example 7 (i.e. Comparative example 6) also provided a method for preparing a high-fluidity magnetic composite material. The method was the same as that in Example 1, except that the types of organic acid in step S30 were different. In this example, inorganic acid (phosphoric acid) was used, and other steps, parameter and the amounts of the ingredients were the same as those in Example 1.

The fluidity of the magnetic composite materials prepared by the method in Example 1 to example 7 were tested. Results are shown in Table 3.

TABLE 3

| | | | Temper- | Pressure | Flow | |
|---|---|---|---|---|---|---|
| Sample | Weight | Pressure | ature | Holding Time | Length | |
| Example 1 | 80 g | 15 Mpa | 175° C. | 35 s | 170 | mm |
| Example 7 | 80 g | 15 Mpa | 175° C. | 35 s | 105 | m |

It can be seen from Table 3 that: given the same pressure, temperature, pressure holding time, and weight, the magnetic composite material prepared by passivating the surface of the metal soft magnetic powder with an organic acid exhibits better flowability compared with those passivated with an inorganic acid.

### Example 8

Example 8 (i.e. Comparative example 7) also provided a method for preparing a high-fluidity magnetic composite material. The method was the same as that in Example 1, except that the molecular weight of the epoxy resin in step S40 was different. In this example, a small-molecular-weight epoxy resin with a molecular weight of less than 20000 g/mol was used, and other steps, parameter and the amounts of the ingredients were the same as those in Example 1.

The fluidity of the magnetic composite material prepared by the method in this example was tested. Results are shown in Table 4.

### Example 9

Example 9 (i.e. Comparative Example 8) also provided a method for preparing a high-fluidity magnetic composite material. The method was the same as that in Example 1, except that the molecular weight of the epoxy resin in step S40 was different. In this example, a high-molecular-weight epoxy resin with a molecular weight of more than 80000 g/mol was used, and other steps, parameter and the amounts of the ingredients were the same as those in Example 1.

The fluidity of the magnetic composite material prepared by the method in this example was tested. Results are shown in Table 4.

TABLE 4

| | | | | Pressure | Flow | | |
|---|---|---|---|---|---|---|---|
| Sample | Weight | Pressure | Temperature | Holding Time | Length | Sample | |
| Example 1 | 80 g | 15 Mpa | 175° C. | 35 s | 170 mm | 1 min 20 s | |
| Example 8 | 80 g | 15 Mpa | 175° C. | 35 s | 200 mm | 20 | s |
| Example 9 | 80 g | 15 Mpa | 175° C. | 35 s | 60 mm | 4 | min |

It can be seen from Table 4 that: given the same pressure, temperature, pressure holding time, and weight, the use of a low-molecular-weight epoxy resin enables the composite material to exhibit super high flowability. However, this results in a significantly shorter curing time for the composite material, which may lead to premature curing and loss of flowability. In Contrast, the use of a high-molecular-weight epoxy resin results in poor flowability and prolongs the curing time.

Therefore, the use of the special medium-molecular-weight of epoxy resin in Example 1 of the present disclosure not only ensures the high fluidity of the magnetic composite material, but also ensures an appropriate curing time, which could prevent the magnetic composite material from losing fluidity due to premature curing caused by too short curing time, and make the magnetic composite material have certain strength and toughness after curing.

In the description of the specification, the description referring to the terms “one embodiment”, “some embodiments”, “examples”, “specific examples”, or “some examples” means that the specific features, structures, materials, or features described in connection with the embodiments or examples are included in at least one embodiment or example of the present disclosure. In the specification, illustrative expressions of the above terms do not necessarily refer to the same embodiments or examples. Moreover, the specific features, structures, materials or features described may be combined in a suitable manner in any one or more embodiments or examples.

The above embodiments only express several embodiments of the present disclosure, and the description is more specific and detailed, but it could not be understood as limiting the scope of the present disclosure. It should be noted that for those skilled in the art, several modifications and improvements could be made without departing from the concept of the disclosure, and several modifications and improvements are deemed as falling within the scope of the present disclosure. Therefore, the scope of the present disclosure should be determined by the appended claims.

What is claimed:

1. A method for preparing a high-fluidity magnetic composite material, comprising the following steps:
providing metal soft magnetic powders with high sphericity, wherein the metal soft magnetic powders have a first particle size, a second particle size, and a third particle size, respectively, the first particle size is 85 μm to 90 μm, the second particle size is 30 μm to 35 μm, and the third particle size is 8 μm to 12 μm;
subjecting the metal soft magnetic powders respectively having the first particle size, the second particle size, and the third particle size to grading according to a predetermined mixing ratio, and then weighing and adding a predetermined mass of a graded metal soft magnetic powder to a mixing device and mixing to obtain a first mixture, the predetermined mixing ratio of the metal soft magnetic powders of the first particle size, the second particle size, and the third particle size being 1:3:9;
weighing an organic acid at a first weight percentage relative to the first mixture, and a diluent at a second weight percentage relative to the first mixture, and mixing the organic acid and the diluent to obtain a diluted organic acid, adding the diluted organic acid to the first mixture in the mixing device and mixing to obtain a second mixture;
weighing an epoxy resin at a third weight percentage relative to the first mixture, and adding the epoxy resin to the second mixture in the mixing device for mixing, the epoxy resin having a molecular weight of 20000 g/mol to 80000 g/mol; and
mixing the epoxy resin with the second mixture for a predetermined time to obtain the high-fluidity magnetic composite material.

2. The method for preparing the high-fluidity magnetic composite material of claim 1, wherein, in the step of weighing and adding the predetermined mass of the graded metal soft magnetic powder to the mixing device and mixing to obtain the first mixture, the mixing is performed at a rotational speed of 50 r/min for 10 minutes.

3. The method for preparing the high-fluidity magnetic composite material of claim 1, wherein 10 kg of the graded metal soft magnetic powder is weighed and added to the mixing device; and
the first weight percentage of the organic acid relative to the first mixture is 1%, and the second weight percentage of the diluent relative to the first mixture is 3%.

4. The method for preparing the high-fluidity magnetic composite material of claim 3, wherein the organic acid is acetic acid and the diluent is ethanol.

5. The method for preparing the high-fluidity magnetic composite material of claim 1, wherein, in the step of adding the diluted organic acid to the first mixture in the mixing device and mixing to obtain the second mixture, the mixed is performed under conditions comprising:
non-vacuum but closed environment, an environment temperature of 40° C., and a rotational speed of 50 r/min.

6. The method for preparing the high-fluidity magnetic composite material of claim 5, further comprising: after the step of adding the diluted organic acid to the first mixture in the mixing device and mixing, sieving a resulting mixture after mixing the diluted organic acid with the first mixture using a 60-mesh sieve to obtain a passivated second mixture that passes through the 60-mesh sieve.

7. The method for preparing the high-fluidity magnetic composite material of claim 1, wherein:
a third weight percentage of the epoxy resin relative to the first mixture is 6%; and
in the step of adding the epoxy resin to the second mixture in the mixing device and mixing, the mixing is performed under conditions comprising:
non-vacuum but closed environment, an environment temperature of 70° C., and a rotational speed of 40 r/min.

8. The method for preparing the high-fluidity magnetic composite material of claim 7, wherein the mixing the epoxy resin with the second mixture is performed for 15 minutes.

9. A high-fluidity magnetic composite material prepared by the method of claim 1.
